(19) United States
(12) Patent Application Publication
(10) Pub. No.: US 2005/0146204 A1
(43) Pub. Date: Jul. 7, 2005

(54) Wheel spinner of vehicle

(76) Inventor: Heon Kyu Kim, Seoul (KR)

Correspondence Address: VENABLE LLP, P.O. BOX 34385, WASHINGTON, DC, 20435-9998, US

(21) Appl. No.: 10/831,104

(22) Filed: Apr. 26, 2004

(30) Foreign Application Priority Data
Dec. 15, 2003 (KR) 10-2003-0091046

(51) Int. Cl. B60B 7/04

(52) U.S. Cl. 301/37.25

(57) ABSTRACT

A wheel spinner of a vehicle includes a rotating shaft coaxially fastened to a center of rotation of a wheel via a wheel connecting member, a wheel spinner body rotatable about the rotating shaft, and positioned at an outer lateral surface of the wheel; a wheel spinner fixing member installed at an opposite side of the wheel connecting member so as to surround the rotating shaft where the wheel spinner fixing member is coupled to the wheel spinner body; and rotation stopping/release means formed at the wheel spinner fixing member, and adapted to fully suppress relative rotation between the wheel spinner body and rotating shaft when the rotating shaft is in a rotation stop position. The wheel spinner of a vehicle is independently rotatable relative to a wheel, when the vehicle is in motion, at a non-constant, irregular rotational speed under the influence of various factors, such as a variable speed of the vehicle, and air flow caused when the vehicle is in motion, thereby enabling an appearance of the wheel spinner and illuminators installed at the wheel spinner to show various aesthetically pleasing views. Since the wheel spinner can rotate at a different rotational speed than that of the wheel, it is possible to enable an observer to visually sense the speed of the vehicle, thereby increasing a visual effect thereof to lovers of vehicles or motorcycles.

### BACKGROUND OF THE INVENTION

1. Field of the Invention

The present invention relates to wheel spinners of vehicles, and more particularly to a wheel spinner of a vehicle wherein it is independently rotatable relative to a wheel axle when the vehicle is in motion, whereas it is stationary relative to the wheel axle when the vehicle comes to a full stop.

2. Description of the Related Art

A wheel spinner of a vehicle, conventionally, is affixed to an outer lateral surface of a wheel in a coaxial relation to a wheel axle, so that it simultaneously rotates with the wheel or fully suppresses rotation. Such a wheel spinner has been used for the simple purpose of achieving an aesthetically pleasing appearance of a wheel. Further, there have been recently developed wheel spinners wherein they are still stationary relative to a rotating wheel when the vehicle is in motion, so as to enable any advertisement copies and designs, carried at a surface thereof, to be legible to an observer even when the vehicle is in motion, resulting in an advertising effect.

However, the conventional wheel spinners are designed either to rotate along with the wheel, or to be stationary relative to the wheel when the vehicle is in motion, and they always maintain a constant rotational speed. Therefore, an appearance of the wheel spinner and any designs printed thereon are perceived by observers without change, deteriorating aesthetically pleasing visual effects of the wheel spinners. Further, since the wheel spinners rotate at the same rotational speed as that of the wheel, it makes it difficult to create sensation of speed of the vehicles, resulting in a disadvantage in that the wheel spinners are monotonous and provide no interest to lovers of vehicles or motorcycles.

### SUMMARY OF THE INVENTION

Therefore, the present invention has been made in view of the above problems, and it is an object of the present invention to provide a wheel spinner of a vehicle wherein it is independently rotatable relative to a wheel when the vehicle is in motion, thereby allowing an appearance of the wheel spinner and any decorations provided thereon to vary according to rotation of the wheel, resulting in various aesthetically pleasing views of the wheel spinner and its decorations.

It is another object of the present invention to provide a wheel spinner of a vehicle wherein it can rotate at a different rotational speed than that of the wheel, enabling an observer to visually sense the speed of the vehicle.

In accordance with one aspect of the present invention, the above and other objects can be accomplished by the provision of a wheel spinner of a vehicle comprising: a rotating shaft fastened to a center of rotation of a wheel via a wheel connecting member so as to independently rotate relative to the wheel, the rotating shaft also being movable in an axial direction of the center of rotation by a certain distance; a wheel spinner body coupled to the rotating shaft so as to simultaneously rotate with the rotating shaft, the wheel spinner body being located at an outer lateral surface of the wheel; movement restriction means adapted to restrict an axial movement distance of the rotating shaft into a range between a rotatable position and rotation stop position of the wheel spinner body; an elastic member installed between the wheel connecting member and the rotating shaft, and adapted to provide elasticity to the rotating shaft for allowing the rotating shaft to be positioned in the rotation stop position; and rotation stopping means adapted to fully suppress rotation of the rotating shaft and wheel spinner body when the rotating shaft is in the rotation stop position.

Preferably, the rotation stopping means may include a holding pin installed at the wheel connecting member, the holding pin being elastically supported by a spring so as to be extended or retracted in a diametrical direction of the rotating shaft, and a holding recess formed at the rotating shaft, into which the holding pin is inserted and captively received when the rotating shaft is in the rotation stop position.

Preferably, the rotation stopping means may include a holding protrusion formed at the wheel spinner body, and a holding groove formed at the wheel connecting member, into which the holding protrusion is inserted and captively received when the rotating shaft is in the rotation stop position.

In accordance with another aspect of the present invention, the above and other objects can be accomplished by the provision of a wheel spinner of a vehicle comprising: a rotating shaft fastened to a center of rotation of a wheel via a wheel connecting member so as to independently rotate relative to the wheel; a wheel spinner body coupled to the rotating shaft so as to simultaneously rotate with the rotating shaft, the wheel spinner body being positioned at an outer lateral surface of the wheel; rotation stopping means installed between the wheel connecting member and the rotating shaft, and adapted to fully suppress rotation of the rotating shaft; and stoppage release means integrally connected to the rotation stopping means, and adapted to release the rotating shaft from the rotation stopping means by using a centrifugal force generated during rotation of the wheel.

Preferably, the rotation stopping means may include holding pins installed at the wheel connecting member so as to be extended or retracted in a diametrical direction of the rotating shaft, holding recesses formed at the rotating shaft for the insertion of the holding pins, and elastic members installed around the holding pins, respectively, so as to provide elasticity to the holding pins for allowing the holding pins to be inserted and captively received in the holding recesses, respectively.

Preferably, the stoppage release means may include centrifugal force generating bodies integrally coupled to the holding pins, respectively, the centrifugal force generating bodiesserving to apply a centrifugal force, produced according to rotation of the wheel, to the holding pins so as to release the holding pins from the holding recesses.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a longitudinal sectional view illustrating a wheel spinner of a vehicle in accordance with a first embodiment of the present invention;

FIG. 2 is a front view illustrating the wheel spinner of a vehicle in accordance with the first embodiment of the present invention;

FIGS. 3a and 3b are enlarged sectional views illustrating an important portion of the wheel spinner shown in FIG. 1, FIG. 3a being a sectional view illustrating a state wherein the vehicle comes to a full stop, and FIG. 3b being a sectional view illustrating a state wherein the vehicle is in motion;

FIGS. 4a and 4b are enlarged sectional views illustrating an important portion of a wheel spinner in accordance with a second embodiment of the present invention, FIG. 4a being a sectional view illustrating a state wherein the vehicle comes to a full stop, and FIG. 4b being a sectional view illustrating a state wherein the vehicle is in motion;

FIG. 5 is a longitudinal sectional view illustrating a wheel spinner of a vehicle in accordance with a third embodiment of the present invention;

FIG. 6 is a front view illustrating the wheel spinner of a vehicle in accordance with the third embodiment of the present invention;

FIGS. 7a and 7b are enlarged sectional views illustrating an important portion of the wheel spinner shown in FIG. 5, FIG. 7a being a sectional view illustrating a state wherein the vehicle comes to a full stop, and FIG. 7b being a sectional view illustrating a state wherein the vehicle is in motion;

FIG. 8 is a longitudinal sectional view illustrating a wheel spinner of a vehicle in accordance with a fourth embodiment of the present invention;

FIG. 9 is a front view illustrating the wheel spinner of a vehicle in accordance with the fourth embodiment of the present invention;

FIG. 10 is an enlarged sectional view illustrating an important portion of the wheel spinner shown in FIG. 8; and

FIGS. 11a and 11b are sectional views taken along the line A-A shown in FIG. 10, FIG. 11a being a sectional view illustrating a stationary state of a rotating shaft, and FIG. 11b being a sectional view illustrating a rotating state of the rotating shaft;

### DESCRIPTION OF THE PREFERRED EMBODIMENTS

Now, preferred embodiments of a wheel spinner of a vehicle in accordance with the invention will be explained in detail in conjunction with the accompanying drawings.

### First Embodiment

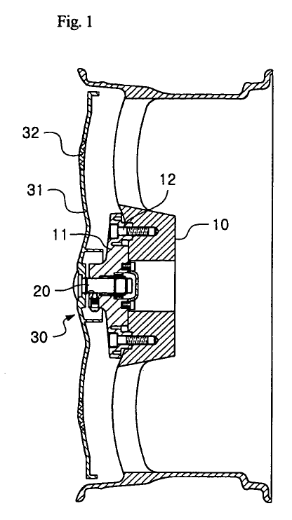

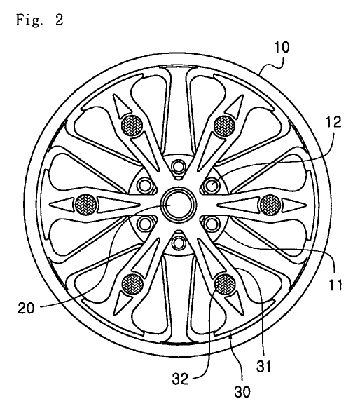

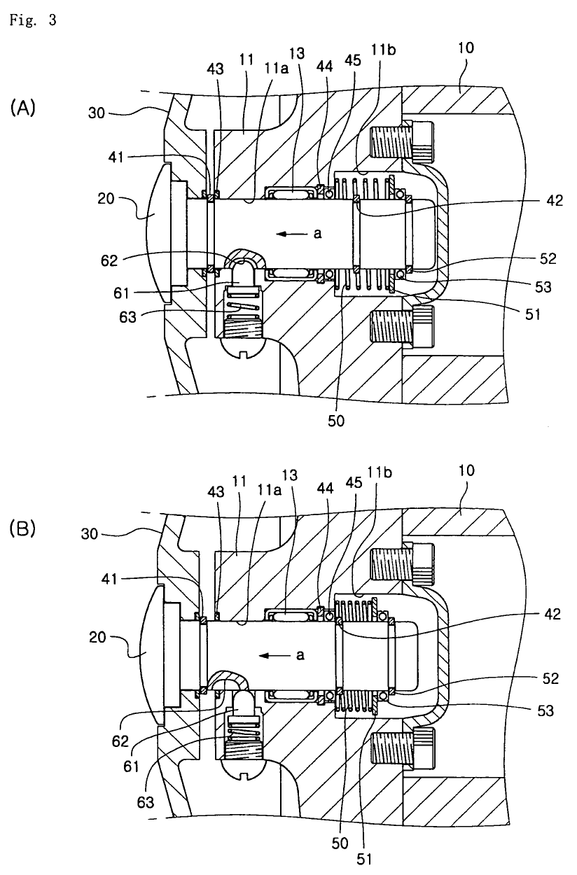

FIGS. 1 and 2 are a longitudinal sectional view and a front view, respectively, illustrating a wheel spinner of a vehicle in accordance with a first embodiment of the present invention. FIGS. 3a and 3b are enlarged sectional views illustrating an important portion of the wheel spinner shown in FIG. 1. Referring to the drawings, the wheel spinner comprises a rotating shaft 20 fastened to a center of rotation of a wheel 10 so as to independently rotate relative to the wheel 10, a wheel spinner body 30 coupled to the rotating shaft 20 so as to simultaneously rotate with the rotating shaft 20, movement restriction means adapted to restrict an axial movement distance of the rotating shaft 20, an elastic member 50 adapted to provide elasticity to the rotating shaft 20 for guiding the rotating shaft 20 to a rotation stop position, and rotation stopping means for restricting rotation of the wheel spinner body 30.

The wheel 10, conventionally, is rotatably coupled to a wheel axle (not shown), and the rotating shaft 20 of the wheel spinner is fastened to the center of rotation of the wheel 10 via a wheel connecting member 11. The wheel connecting member 11 is fixedly fastened to a boss portion of the wheel 10 by using bolts 12. Such a wheel connecting member 11 internally defines a rotation maintenance bore 11a for allowing the rotating shaft 20 to be coaxially installed to the center of rotation of the wheel 10 in a freely rotatable manner, and a widened bore 11b having a diameter slightly larger than that of the rotation maintenance bore 11a. The rotation maintenance bore 11a and widened bore 11b are successively defined in an axial direction.

The rotating shaft 20 is fastened to the center of rotation of the wheel 10 so that it independently rotates relative to the wheel 10, as well as is axially movable by a desired distance. More particularly, the rotating shaft 20 is inserted into the rotation maintenance bore 11a of the wheel connecting member 11, and is rotatably supported by a linear bearing 13. In such an inserted state, one end of the rotating shaft 20 is exposed to the outside, and the wheel spinner body 30 is coupled to the exposed end. The other end of the rotating shaft 20 is seated inside the widened bore 11b of the wheel connecting member 11. Here, since the role of the linear bearing 13 is generally to enable axial movement of the rotating shaft 20 as well as to rotatably support the rotating shaft 20, the rotating shaft 20 is freely movable in the axial direction.

The wheel spinner body 30 is coupled, at a center of rotation thereof, to the exposed end of the rotating shaft 20 so that it simultaneously rotates with the rotating shaft 20. The wheel spinner body 30 comprises a plurality of radially extending rotating blades 31. These plural rotating blades 31 are equally spaced apart from one another in a circumferential direction of the wheel spinner body 30 so that their ends are arranged along a circumference of the wheel spinner body 30, forming a partially contiguous circle. The rotating blades 31 have approximately the same length as an outer diameter of the wheel 10 so as to mostly cover an exposed lateral surface of the wheel 10.

Each of the plural rotating blades 31 has an illuminator 32. The illuminator 32 may be a reflector or noctilucent matter not requiring a separate electricity source, or a light emitting diode or bulb adapted to be turned on through the use of a battery.

The movement restriction means serves to restrict an axial movement distance of the rotating shaft 20 into a range between a rotatable position for securing free rotation of the wheel spinner body 30 and a rotation stop position for restricting rotation of the wheel spinner body 30 and rotating shaft 20. The movement restriction means comprises two stop rings 41 and 42. One of the stop rings 41 is fitted around the rotating shaft 20 so that it is affixed to the wheel spinner body 30. A fixing ring 43 is affixed to an opposite side of the wheel connecting member 11, and is adapted to stop an axial movement of the rotating shaft 20 as it comes into contact with the stop ring 41, thereby setting the rotation stop position of the wheel spinner body 30 and rotating shaft 20.

The other one of the stop rings 42 is fitted around a portion of the rotating shaft 20 located inside the widened bore 11b of the wheel connecting member 11. A fixing ring 44 is mounted inside the rotation maintenance bore 11a of the wheel connecting member 11, and is adapted to stop the axial movement of the rotating shaft 20 as it comes into contact with the stop ring 42, thereby setting a rotatable position. Preferably, a thrust bearing 45 is interposed between the stop ring 42 and fixing ring 44, in order to rotatably support the rotating shaft 20 while preventing generation of friction between the stop ring 42 and fixing ring 44.

The elastic member 50 is a coil spring, which is supported, on the one hand, by a loop-shaped support plate 51 fixedly fitted near the one end of the rotating shaft 20 located in the widened bore 11b of the wheel connecting member 11, and, on the other hand, by a stepped portion of the wheel connecting member 11 inside the widened bore 11a. Here, since the support plate 51 is further supported by a supporting ring 52, and the support plate 51 is immobile, and conversely, the supporting ring 52 is rotatable, a thrust bearing 53 is interposed between the support plate 51 and supporting ring 52, in order to rotatably support the rotating shaft 20 while preventing generation of friction between the support plate 51 and supporting ring 52.

The coil spring 50, installed as stated above, is compressed when the rotating shaft 20 moves in the direction of the arrow (a) by a centrifugal force produced according to rotation of the wheel spinner body 30. When the centrifugal force ceases to be applied, the coil spring 50 acts to return the rotating shaft 20 to an original position thereof by means of its elastic restoring force.

The rotation stopping means serves to fully suppress the rotation of the wheel spinner body 30 by engaging the wheel spinner body 30 and rotating shaft 20 to the wheel connecting member 11 when the wheel spinner body 30 is in the rotation stop position. For this, the rotation stopping means comprises a holding pin 61 installed at the wheel connecting member 11, and a holding recess 62 formed at the rotating shaft 20.

The holding pin 61 is installed so as to be extended or retracted in a diametrical direction of the rotating shaft 20 by means of elasticity of a spring 63, and a tip end of the holding pin 61 is rounded to form a smoothly curved end. The holding recess 62 has a shape corresponding to that of the tip end of the holding pin 61, and is formed at a position capable of captively receiving the holding pin 61 when the rotating shaft 20 is in the rotation stop position.

With the wheel spinner in accordance with the first embodiment as stated above, as shown in FIG. 3a, in a state wherein the vehicle comes to a full stop, the wheel 10 and wheel spinner body 30 are stationary, and the holding pin 61 is inserted and captively received in the holding recess 62. In this state, if the wheel 10 rotates as the vehicle starts to move, due to the holding pin 61 caught by the holding recess 62, the rotating shaft 20 and the wheel spinner body 30 coupled thereto initially rotate together.

Subsequently, under the influence of a centrifugal force produced according to the rotation of the wheel spinner body 30, and other factors, including air flow passing through the wheel spinner body 30 and wheel 10 caused when the vehicle is in motion, a thrust force is generated to cause the wheel spinner body 30 to move away from the wheel 10 (in the direction of the arrow (a)). Such a thrust force increases as a rotational speed of the wheel 10 increases.

If the speed of the vehicle increases, and thus the thrust force, axially acting on the wheel spinner body 30, is larger than the elasticity of the spring 63 coupled to the holding pin 61 and of the coil spring 50 fitted around the rotating shaft 20, as shown in FIG. 3b, both the coil spring 50 and spring 63 are compressed, and, at the same time, the holding pin 61 is released from the holding recess 62. Thereby, the rotating shaft 20 axially moves toward its rotatable position (in the direction of the arrow (a)), and stops at that position as the stop ring 42 located in the region of the coil spring 50 moves, and comes into contact with the thrust bearing 45 installed at the stepped portion of the wheel connecting member 11.

In this way, the rotating shaft 20 reaches the rotatable position when the vehicle is in motion. In this rotatable position, the wheel spinner body 30 independently rotates relative to the wheel 10, it freely rotates, under the influence of a centrifugal force produced according to the rotation of the wheel 10 and other factors including air flow caused when the vehicle is in motion, at a non-constant, irregular rotational speed. This allows an appearance of the wheel spinner body 30 and the illuminators 32 mounted on the wheel spinner body 30 to show various views depending on variation of the rotational speed of the wheel spinner body 30. Further, the wheel spinner body 30 rotates at a different speed from that of the wheel 10, thereby enabling observers to visually sense the speed of the vehicle.

In the above described state, if the wheel 10 rotates at a low speed or comes to a full stop due to low speed motion, temporary stop, or parking of the vehicle, and thus the thrust force of the rotating shaft 20, acting in the direction of the arrow (a), is smaller than the elastic restoring force of both the coil spring 50 and spring 63, the rotating shaft 20 is returned to its original position, that is, the rotation stop position by the elastic restoring force of the coil spring 50, and stops its returning movement as the stop ring 41 affixed to the wheel spinner body 30 comes into contact with the fixing ring 43 affixed to the wheel connecting member 11. At the same time, the holding pin 61 is inserted into the holding recess 62 by going round the rotating shaft 20, and is captively received in the holding recess 62 by virtue of the elastic restoring force of the spring 63. In this way, the rotating shaft 20 and wheel spinner body 30 fully suppress rotation, and thus are stationary. In such a state wherein the vehicle comes to a full stop, since the wheel spinner body 30 does not rotate, there is no risk of catching fingers, especially, of children.

### Second Embodiment

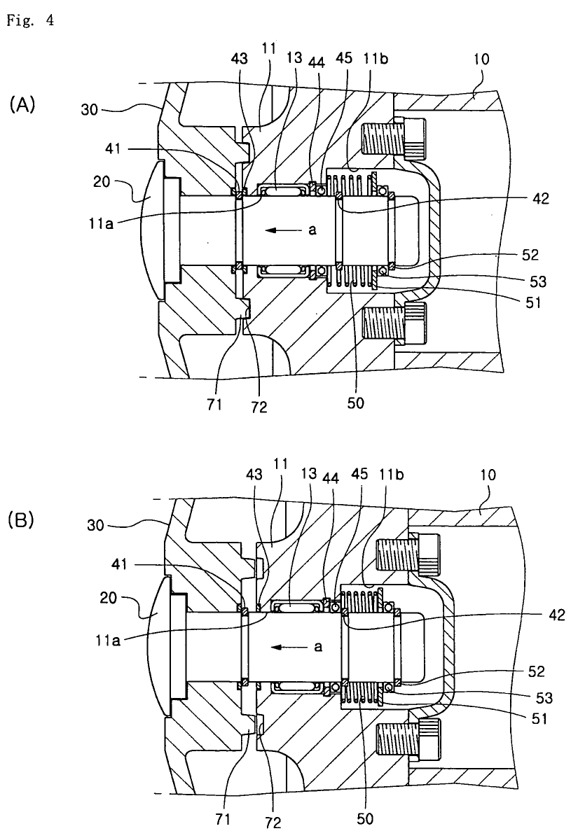

FIGS. 4a and 4b illustrate a rotating structure of the wheel spinner body 30 in accordance with a second embodiment of the present invention. Since the present embodiment is substantially the same as the first embodiment except for the rotation stopping means adapted to stop the rotation of the wheel spinner body 30 when the rotating shaft 20 reaches the rotation stop position, the same reference numerals are used for the same parts, and their detailed description is omitted. Now, only the rotation stopping means, different from that of the first embodiment will be explained.

The rotation stopping means in accordance with the present embodiment comprises a holding protrusion 71 formed at the wheel spinner body 30, and a holding groove 72 formed at the wheel connecting member 11 and adapted to allow the holding protrusion 71 to be inserted and captively received therein when the rotating shaft 20 is in the rotation stop position.

With the rotation stopping means configured as stated above, in a state wherein the vehicle is in motion as shown in FIG. 4b, if the wheel 10 rotates at a low speed or comes to a full stop due to low speed motion, temporary stoppage, or parking of the vehicle, and thus the thrust force of the rotating shaft 20, acting in the direction of the arrow (a), is smaller than the elastic restoring force of the coil spring 50, as shown in FIG. 4a, the rotating shaft 20 is returned to its original position, and moves to the rotation stop position by virtue of the elastic restoring force of the coil spring 50.

As the rotating shaft 20 moves toward its original position, the holding protrusion 71 of the wheel spinner body 30 first comes into contact with a facing surface of the wheel connecting member 11 while rotating, and then is inserted and captively received in the holding groove 72 at a time that it coincides with the holding groove 72. In this way, the rotating shaft 20 and wheel spinner body 30 fully suppress rotation, and thus are stationary, and the axial movement of the rotating shaft 20 stops as the stop ring 41 comes into contact with the fixing ring 43 of the wheel connecting member 11. In such a state wherein the vehicle comes to a full stop, since the wheel spinner body 30 does not rotate, there is no risk of catching fingers, especially, of children

### Third Embodiment

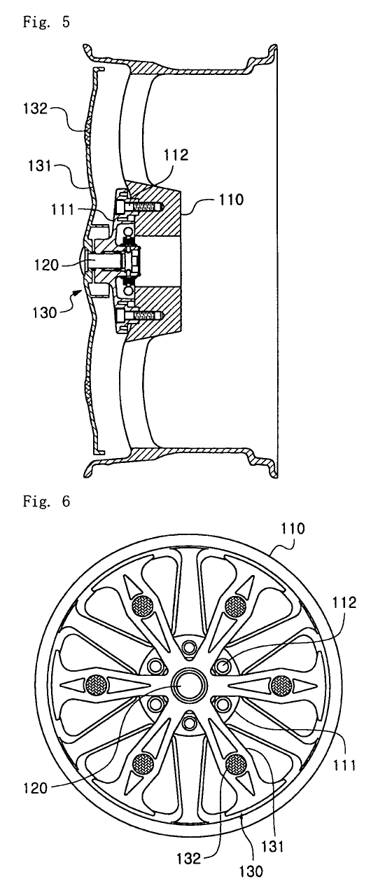

FIGS. 5 to 7b illustrate a wheel spinner in accordance with a third embodiment of the present invention. The wheel spinner comprises a rotating shaft 120 fastened to a center of rotation of a wheel 110 so as to independently rotate relative to the wheel 110, a wheel spinner body 130 coupled to the rotating shaft 120 so as to simultaneously rotate with the rotating shaft 120, rotation stopping means for preventing rotation of the rotating shaft 120 when the wheel 110 is stationary, and stoppage release means for enabling rotation of the rotating shaft 20 when the wheel 110 rotates.

The wheel 110, generally, is rotatably coupled to a driving axle of the vehicle (not shown), and, the rotating shaft 120 of the wheel spinner is fastened to the center of rotation of the wheel 110 via a wheel connecting member 111. The wheel connecting member 111 is fixedly fastened to a boss portion of the wheel 110 by using bolts 112. Such a wheel connecting member 111 internally defines a rotation maintenance bore 111a, for allowing the rotating shaft 120 to be coaxially installed along the center of rotation of the wheel 10 in a freely rotatable manner, and a widened bore 111b having a diameter slightly larger than that of the rotation maintenance bore 111a. The rotation maintenance bore 111a and widened bore 111b are successively defined in an axial direction.

The rotating shaft 120 is fastened to the center of rotation of the wheel 110 so as to independently rotate relative to the wheel 110. More particulalrly, the rotating shaft 120 is inserted into the rotation maintenance bore 111a of the wheel connecting member 111, and is rotatably supported by a linear bearing 113. In such an inserted state, one end of the rotating shaft 120 is exposed to the outside, and the wheel spinner body 130 is mounted to the exposed end. The other end of the rotating shaft 120 is seated inside the widened bore 111b of the wheel connecting member 111. A thrust bearing 146 is interposed between the wheel spinner body 130 and wheel connecting member 111, and a thrust bearing 145 is interposed between a fixing ring 144 installed in the rotation maintenance bore 111a of the wheel connecting member 111 and a stop ring 142 fitted around the rotating shaft 120. These thrust bearings 146 and 145 simultaneously serve to rotatably support a contact portion between the wheel spinner body 130 and wheel connecting member 111, and to prevent axial movement of the wheel spinner body 130 and wheel connecting member 111 relative to the rotating shaft 120.

The wheel spinner body 130 is coupled, at a center of rotation thereof, to the exposed end of the rotating shaft 120 so that it simultaneously rotates with the rotating shaft 120. The wheel spinner body 130 comprises a plurality of radially extending rotating blades 131. These plural rotating blades 131 are equally spaced apart from one another in a circumferential direction of the wheel spinner body 30 so that their distal ends are arranged along a circumference of the wheel spinner body 130, forming a partially contiguous circle. The rotating blades 131 have approximately the same length as an outer diameter of the wheel 110 so as to mostly cover an exposed lateral surface of the wheel 110.

Each of the rotating blades 131 has an illuminator 132. The illuminator 132 may be a reflector or noctilucent matter not requiring a separate electricity source, or a light emitting diode or bulb adapted to be turned on through the use of a battery.

The rotation stopping means is installed between the wheel connecting member 111 and rotating shaft 120, and is adapted to prevent rotation of the rotating shaft 120. For this, a fixed bracket 114 is installed at an outer peripheral surface of the wheel connecting member 11 around the widened bore 111b, and holding pins 161 are fitted in the fixed bracket 114 so as to be extended or retracted in a diametrical direction of the rotating shaft 120. The rotating shaft 120 is formed, at positions corresponding to the holding pins 161, with holding recesses 162 for the insertion of the holding pins 161. Each holding pin 161 is fitted therearound with an elastic member 163 having a desired elasticity required for allowing the holding pin 161 to be inserted and captively received in the holding recess 162. In this case, preferably, an inner end of the holding pin 161 has a semi-spherical shape, and the corresponding holding recess 162 also has a semi-spherical shape, in order to facilitate smooth engagement and disengagement therebetween.

The stoppage release means is connected to the rotation stopping means, and is adapted to release the rotating shaft 120 from the rotation stopping means by using a centrifugal force produced according to rotation of the wheel 110. The stoppage release means comprises a plurality of centrifugal force generating bodies 164, which are located at the outside of the fixed bracket 114 and are integrated to the holding pins 161, respectively. The centrifugal force generating bodies 164 function to release the holding pins 161 from the holding recesses 162 by using the centrifugal force produced according to the rotation of the wheel 10.

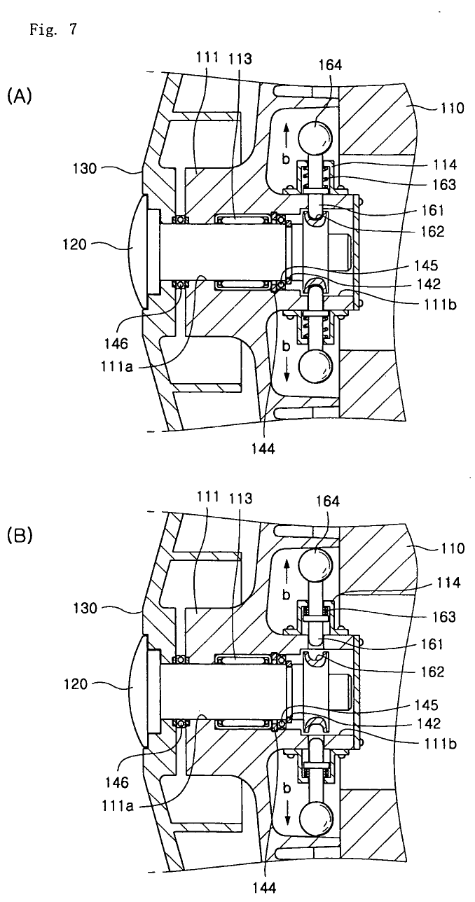

With the wheel spinner of the third embodiment, as shown in FIG. 7a, in a state wherein the vehicle comes to a full stop, the wheel 110 and wheel spinner body 130 are stationary, and the holding pins 161 of the wheel connecting member 111 are inserted and captively received in the holding recesses 162 formed at the rotating shaft 120, respectively. In this state, if the wheel 110 rotates as the vehicles starts to move, due to the holding pins 162 caught by the holding recesses 162, the rotating shaft 120 and the wheel spinner body 130 coupled thereto initially rotate together, and the centrifugal force generating bodies 164 simultaneously rotate about the rotating shaft 120.

Subsequently, the centrifugal force generating bodies 164 generate a centrifugal force (acting in the direction of the arrow (b)). Such a centrifugal force increases as a rotational speed of the wheel 110 increases.

If the speed of the vehicle increases, and thus the centrifugal force generated by the centrifugal force generating bodies 164 is larger than elasticity of the elastic members 163 fitted around the holding pins 161, as shown in FIG. 7b, the elastic members 163 are compressed, and, at the same time, the holding pins 161 are released from the holding recesses 162. Thereby, the rotating shaft 120 freely rotates relative to the wheel connecting member 111.

In this way, the rotating shaft 120 is in the freely rotatable state when the vehicle is in motion, and thus the wheel spinner body 130 freely rotates, under the influence of the centrifugal force produced according to the rotation of the wheel 110 and other factors including air flow caused by the motion of the vehicle, at a non-constant irregular rotational speed. This allows an appearance of the wheel spinner body 130 and the illuminators 132 of the wheel spinner body 130 to show various views depending on variation of the rotational speed of the wheel spinner body 130. Further, the wheel spinner body 130 rotates at a different speed than that of the wheel 110, thereby enabling observers to visually sense the speed of the vehicle.

In the above described state, if the wheel 110 rotates at a low speed or comes to a full stop due to low speed motion, temporary stop, or paring of the vehicle, and thus the centrifugal force acting on the centrifugal force generating bodies 164 is smaller than an elastic restoring force of the elastic members 163, the holding pins 161 tend to move toward the holding recesses 162 by virtue of the elastic restoring force of the elastic members 163.

Accordingly, the holding pins 161 go round the rotating shaft 120, and then are inserted and captively received in the holding recesses 162 at a time that they coincide with the holding recesses 162. In this way, the rotating shaft 120 and wheel spinner body 130 fully suppress rotation, and thus are stationary. In such a state wherein the vehicle comes to a full stop, since the wheel spinner body 130 does not rotate, there is no risk of catching fingers, especially, of children.

### Fourth Embodiment

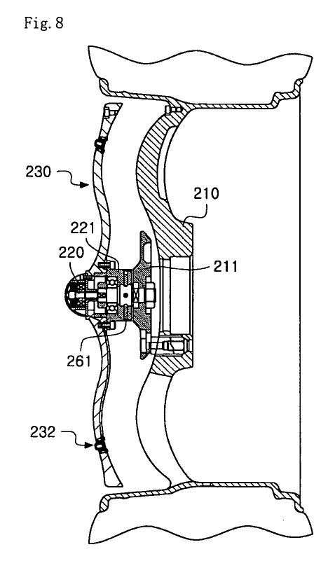

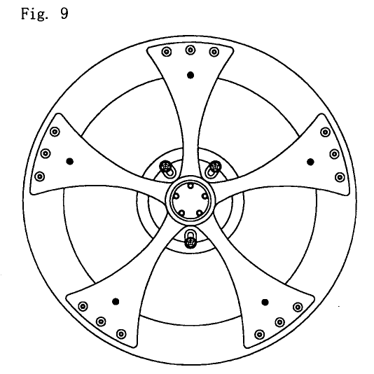

FIGS. 8 to 11b illustrate a wheel spinner in accordance with a fourth embodiment of the present invention The wheel spinner comprises a rotating shaft 220 fastened to a center of rotation of a wheel 210 so as to independently rotate relative to the wheel 210, a wheel spinner body 230 rotatably coupled to the rotating shaft 220, and rotation stopping/release means adapted to prevent rotation of the wheel spinner body 230 when the wheel 210 is stationary, and to enable rotation of the rotating shaft 20 when the wheel 210 rotates.

The wheel 210, generally, is rotatably coupled to a driving axle of the vehicle (not shown), and, the rotating shaft 220 of the wheel spinner is fastened to the center of rotation of the wheel 210 via a wheel connecting member 211. The wheel connecting member 211 is fixedly bolted to a boss portion of the wheel 210.

The rotating shaft 220 is fastened to the center of rotation of the wheel 210. More particularly, one end of the rotating shaft 220 is inserted into the rotation maintenance bore 211a of the wheel connecting member 211, and the other end of the rotating shaft 220 is inserted into a cap 235, which will be described hereinafter.

A wheel spinner fixing member 221 is installed at an opposite side of the wheel connecting member 211 so that it surrounds the rotating shaft 220. The wheel spinner fixing member 221 is further bolted to the wheel spinner body 230. A ball bearing 213 is interposed between the wheel spinner fixing member 221 and rotating shaft 220, and is adapted to rotatably support the wheel spinner fixing member 221 about the rotating shaft 220. At a front side of the ball bearing 213 is mounted a fixing ring 214.

The cap 235 is coupled to the other end of the rotating shaft 220 being exposed to the outside so that it is fixedly attached to a base plate 239 having an approximately L-shaped cross section. The base plate 239 is adapted to rotate at a different rotational speed than that of the rotating shaft 220, and this may cause generation of frictional stress therebetween. Therefore, in order to solve this frictional stress problem, a bushing 238 is interposed between the base plate 239 and the rotating shaft 220.

Along an outer peripheral surface of the other end of the rotating shaft 220, which is inserted in the cap 235 as stated above, is disposed a magnet 236 having a plurality of north-poles and south-poles alternately and repeatedly arranged in a circumferential direction thereof. A coil is further disposed at an outer side of the magnet 236 being exposed to the outside, and is adapted to generate an electric current under the influence of a magnetic field of the magnet 236. The generated electric current is adapted to flow along an electric wire 234, so as to turn on illuminators, which will be described hereinafter.

The wheel spinner body 230 is fixedly bolted to the wheel spinner fixing member 221 coaxially with the rotating shaft 220 so that it is rotatable relative to the rotating shaft 220. The wheel spinner body 230 comprises a plurality of radially extending rotating blades 231 equally spaced apart from one other in a circumferential direction thereof. In the present embodiment, a circumference of the wheel spinner body 230 is divided into five sections so as to arrange five rotating blades 231. The rotating blades 231 have approximately the same length as an outer diameter of the wheel 210 so as to mostly cover an exposed lateral surface of the wheel 210.

Each of the rotating blades 231 has an illuminator 232. Preferably, the illuminator 232 may be a light emitting diode, and may be turned on by an electricity generating structure using the magnet 236 and coil 237.

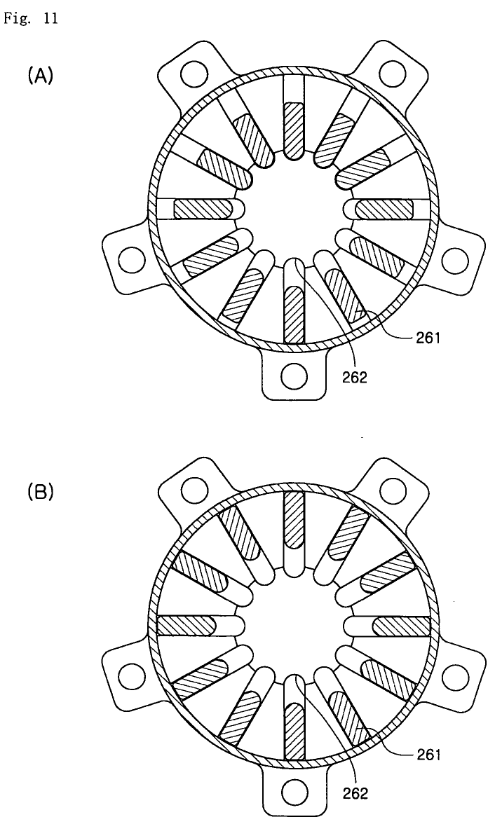

The rotation stopping/release means is installed to the wheel spinner fixing member 221, and is adapted to prevent the wheel spinner body 230 from rotating relative to the rotating shaft 220. As shown in FIGS. 11a and 11b, the rotation stopping/release means comprises a plurality of holding pins 261. The wheel spinner fixing member 221 is formed along a circumference thereof with a plurality of holding pin holes 261a, so that the plural holding pins 261 are inserted into the plural holding pin holes 261a, respectively, so as to be extended or retracted in a diametrical direction of the rotating shaft 220. To the outside of the plural holding pin holes 261 is installed a fixing bracket 264 for preventing the separation of the holding pins 261. The rotating shaft 220 is formed, at positions corresponding to the holding pins 261, with holding recesses 262 for the insertion of the holding pins 261.

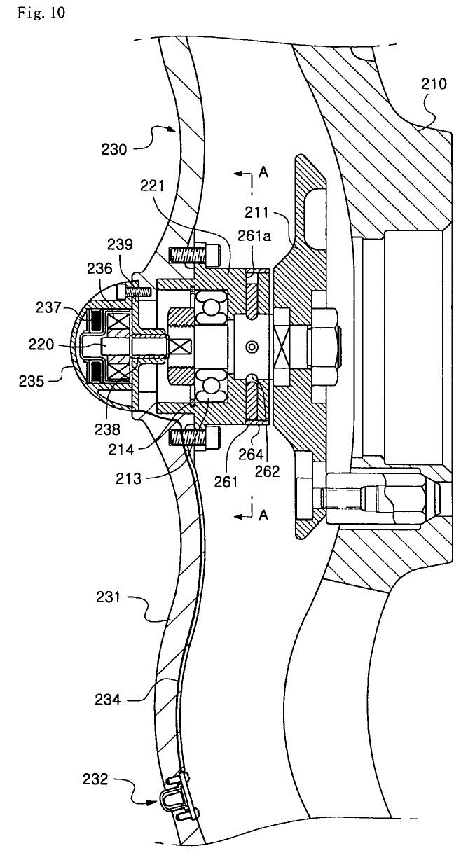

With the wheel spinner in accordance with the fourth embodiment, as shown in FIG. 10, in a state wherein the vehicle comes to a full stop, the wheel 210 and wheel spinner body 230 are stationary. In this stationary state, as shown in FIG. 11a, upper ones among the holding pins 261 of the wheel spinner fixing member 221 are inserted and captively received in the holding recesses 262 of the rotating shaft 220 by the force of gravity. In this state, if the wheel 210 rotates as the vehicle starts to move, due to the upper holding pins 261 caught by the holding recesses 262, the rotating shaft 220 and the wheel spinner body 230 coupled thereto initially rotate together. Further, the holding pins 261 simultaneously rotate about the rotating shaft 220.

The holding pins 261 generate a centrifugal force according to their rotation. This generated centrifugal force increases as a rotational speed of the wheel 210 increases.

If the holding pins 261 are subjected to the centrifugal force as the speed of the vehicle further increases, as shown in FIG. 11b, the holding pins 261 are released from the holding recesses 262, and thus the wheel spinner body 230 is independently rotatable relative to the rotating shaft 220 and wheel connecting member 211.

As stated above, when the vehicle is in motion, although the rotating shaft 220 rotates at the same rotational speed as that of the wheel 210 since it is connected to the wheel 210 via the wheel connecting member 211, the wheel spinner body 230 is independently rotatable at a non-constant, irregular rotational speed since it released by the centrifugal force generated according to the rotation of the wheel 210. At the same time with the rotation of the rotating shaft 220, further, the illuminators 232 are turned on by the electricity generating structure inserted in the cap. Further, the wheel spinner body 230 rotates at a different speed than that of the wheel 210, thereby enabling observers to visually sense the speed of the vehicle.

When the vehicle comes to a full stop, since the wheel spinner body 230 does not rotate, there is no risk of catching fingers, especially, of children.

As apparent from the above description, the present invention provides a wheel spinner of a vehicle wherein it is independently rotatable relative to a wheel, when the vehicle is in motion, at a non-constant, irregular rotational speed under the influence of various factors, such as a variable speed of the vehicle, and air flow caused when the vehicle is in motion, thereby enabling an appearance of the wheel spinner and illuminators installed at the wheel spinner to show various aesthetically pleasing views.

Further, according to the present invention, since the wheel spinner can rotate at a different rotational speed than that of the wheel, it is possible to enable an observer to visually sense the speed of the vehicle, thereby increasing a visual effect thereof to lovers of vehicles or motorcycles.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A wheel spinner of a vehicle comprising:
a rotating shaft fastened to a center of rotation of a wheel via a wheel connecting member so as to independently rotate relative to the wheel, the rotating shaft also being movable in an axial direction of the center of rotation by a certain distance;
a wheel spinner body coupled to the rotating shaft so as to simultaneously rotate with the rotating shaft, the wheel spinner body being located at an outer lateral surface of the wheel;
movement restriction means adapted to restrict an axial movement distance of the rotating shaft into a range between a rotatable position and rotation stop position of the wheel spinner body;
an elastic member installed between the wheel connecting member and the rotating shaft, and adapted to provide elasticity to the rotating shaft for allowing the rotating shaft to be positioned in the rotation stop position; and
rotation stopping means adapted to fully suppress rotation of the rotating shaft and wheel spinner body when the rotating shaft is in the rotation stop position.

2. The wheel spinner as set forth in claim 1, wherein the rotation stopping means includes:
a holding pin installed at the wheel connecting member, the holding pin being elastically supported by a spring so as to be extended or retracted in a diametrical direction of the rotating shaft; and
a holding recess formed at the rotating shaft, into which the holding pin is inserted and captively received when the rotating shaft is in the rotation stop position.

3. The wheel spinner as set forth in claim 1, wherein the rotation stopping means includes:
a holding protrusion formed at the wheel spinner body; and
a holding groove formed at the wheel connecting member, into which the holding protrusion is inserted and captively received when the rotating shaft is in the rotation stop position.

4. A wheel spinner of a vehicle comprising:
a rotating shaft fastened to a center of rotation of a wheel via a wheel connecting member so as to independently rotate relative to the wheel;
a wheel spinner body coupled to the rotating shaft so as to simultaneously rotate with the rotating shaft, the wheel spinner body being positioned at an outer lateral surface of the wheel;
rotation stopping means installed between the wheel connecting member and the rotating shaft, and adapted to fully suppress rotation of the rotating shaft; and
stoppage release means integrally connected to the rotation stopping means, and adapted to release the rotating shaft from the rotation stopping means by using a centrifugal force generated during rotation of the wheel.

5. The wheel spinner as set forth in claim 4, wherein the rotation stopping means includes:
holding pins installed at the wheel correcting member so as to be extended or retracted in a diametrical direction of the rotating shaft;
holding recesses formed at the rotating shaft for the insertion of the holding pins; and
elastic members installed around the holding pins, respectively, so as to provide elasticity to the holding pins for allowing the holding pins to be inserted and captively received in the holding recesses, respectively.

6. The wheel spinner as set forth in claim 5, wherein the stoppage release means includes centrifugal force generating bodies integrally coupled to the holding pins, respectively, the centrifugal force generating bodies serving to apply a centrifugal force, produced according to rotation of the wheel, to the holding pins so as to release the holding pins from the holding recesses.

7. The wheel spinner as set forth in any one of claims 1 to 6, wherein the wheel spinner body includes a plurality of rotating blades equally spaced apart from one other in a circumferential direction, ends of the rotating blades being positioned along a circumference of the wheel spinner body, forming a partially contiguous circle, the rotating blades having approximately the same length as an outer diameter of the wheel so as to mostly cover the exposed outer lateral surface of the wheel.

8. The wheel spinner as set forth in any one of claims 1 to 6, wherein the wheel spinner body includes a plurality of illuminators.

9. A wheel spinner of a vehicle comprising:
a rotating shaft coaxially fastened to a center of rotation of a wheel via a wheel connecting member;
a wheel spinner body rotatable about the rotating shaft, and positioned at an outer lateral surface of the wheel;
a wheel spinner fixing member installed at an opposite side of the wheel connecting member so as to surround the rotating shaft, the wheel spinner fixing member being coupled to the wheel spinner body; and
rotation stopping/release means formed at the wheel spinner fixing member, and adapted to fully suppress relative rotation between the wheel spinner body and rotating shaft when the rotating shaft is in a rotation stop position.

10. The wheel spinner as set forth in claim 9, wherein the rotation stopping/release means includes:
a plurality of holding pins to be positioned in holes formed at the wheel spinner fixing member;
a plurality of holding recesses adapted to allow upper ones among the holding pins to be caught therein by the force of gravity when the rotating shaft is in the rotation stop position; and
a fixing bracket adapted to prevent separation of the holding pins due to a centrifugal force generated according to rotation of the rotating shaft.

11. The wheel spinner as set forth in claim 9, further comprising:
an electricity generating structure having a magnet disposed in a circumferential direction of one end of the rotating shaft and a coil disposed at an outer side of the magnet;
a cap disposed to cover the electricity generating structure; and
illuminators adapted to be turned on by using an electric current generated by the electricity generating structure as the rotating shaft rotates.

12. The wheel spinner as set forth in any one of claims 9 to 11, wherein the wheel spinner body comprises a plurality of rotating blades equally spaced apart from one another in a circumferential direction, each having approximately the same length as an outer diameter of the wheel so as to mostly cover the exposed outer lateral surface of the wheel.
